(19) United States
(12) Patent Application Publication
(10) Pub. No.: US 2005/0172165 A1
(43) Pub. Date: Aug. 4, 2005

(54) Mainframe with multiple switchable disks

(76) Inventor: Shen Xianrong, Shanghai (CN)

Correspondence Address: STANDLEY LAW GROUP LLP, 495 METRO PLACE SOUTH, SUITE 210, DUBLIN, OH, 43017, US

(21) Appl. No.: 11/035,588

(22) Filed: Jan. 14, 2005

(30) Foreign Application Priority Data
Jan. 16, 2004 (CN) 200420019582.X

(51) Int. Cl. G06F 11/00

(52) U.S. Cl. 714/15

(57) ABSTRACT

A 2×N (N≧2) is deployed between the output interfaces of power supply and input interfaces of hard disks; two four-pin outlets for the hard disks are deployed in the power supply, whose two black wires in the middle are grounded together with the case, the back plane grounding and the power interface and whose red wire and yellow wire are connected to different joints of the 2×N switch. The present invention aims at solving the technical problems that present multi-HD mainframe, which parallels multiple hard disks with data lines and a number of joints of the same power supply, is over-simply structured and liable to virus infection by providing a mainframe with multiple switchable disks which enlarges the storage capacity of the computer and which will still be able to function after a hard disk (especially the master disk) is infected.

### TECHNICAL FIELD OF THE INVENTION

The present invention is in the field of computer hardware. Specifically, the present invention relates to a computer mainframe design having multiple switchable disks.

### BACKGROUND AND SUMMARY OF THE INVENTION

Storage capacity need by software is increasing with developing computer technology, which has put forward a stringent demand on the capacity of storage devices. The capacity of one single hard disk is now below customer's requirements, and mainframes with bi-HD or multi-HD emerge as the times require. However, viruses are always nightmares, especially to those people who work in offices and who have to share an online or offline computer with others, for those computers are more liable to be infected. Besides, the whole situation is worsened by file and data corruption caused by wrong deletion and modification in mis-operations from time to time.

Even when hard disks are partitioned for multi-users in a bi-HD (or multi-HD) mainframe, the situation is hardly any better in that present multi-HD mainframe parallels multiple hard disks by data line and a number of joints of the same power supply. Of those disks, one is the master disk and the others are slave disks. The fact that all disks share a primary partition (namely the master disk) means exactly the same probability of virus infection, for all files and data needed to boot the OS are saved in the primary partition and all logic partitions have to call files and data in the primary partition in order to function (from the hard disks). Moreover, the load of power supply must be taken into consideration, for the computer may not be able to boot or may be down after start-up if the power supply is overloaded due to multiple hard disks (including external hard drives). Once the primary partition (i.e. the master disk) is infected by virus, other logic partitions will not be able to execute any operation due to failing to call system files. In other words, once the master disk gets infected, the mainframe is down. The so-called multi-HD only enlarges storage capacity but is no better than a single hard disk in virus protection.

The present invention aims at solving the technical problems that present multi-HD mainframe, which parallels multiple hard disks with data lines and a number of joints of the same power supply, is over-simply structured and liable to virus infection by providing a mainframe with multiple switchable disks which enlarges the storage capacity and which will still be able to function after an infected hard disk (especially the master disk) is switched off.

Detailed descriptions are as follows:

This is a kind of mainframe with multiple switchable disks, which consists of power supply and two or more hard disks connected by data lines. The characteristics of it are as follows: a 2×N switch (N≧2) is deployed between the output interfaces of power supply and input interfaces of hard disks; two four-pin outlets for the hard disk are deployed in the power supply, whose two black wires in the middle are grounded together with the case, the back plane grounding and the power interface and whose red wire and yellow wire are connected to different joints of the 2×N switch.

The 2×N switch (N≧2) is deployed on the mainframe panel.

The 2×N switch (N≧2) works with 220V, 3A.

The effect of the present invention is as following according to the content above. The present invention consists of power supply and two or more hard disks connected by data lines. A 2×N switch (N≧2) is deployed between the output interfaces of power supply and input interfaces of hard disks. When a hard disk (master disk) gets infected, it can be switched off by the 2×N switch while at the same time other hard disks remain power-on so won't be affected, which enable this mainframe to function despite the infection of the master disk. The mainframe should be turned off when switching the hard disks.

The multiple disks in the present invention will enlarge the storage capacity of computer. Moreover, each disk can be installed with an independent OS so that the mainframe will be able to function even when a disk (especially the master disk) gets infected.

In view of the present disclosure or through practice of the present invention, other advantages may become apparent.

### BRIEF DESCRIPTION OF THE DRAWINGS

FIG. 1 is the structural representation of the present invention.

FIG. 2 is the structural representation of the interfaces.

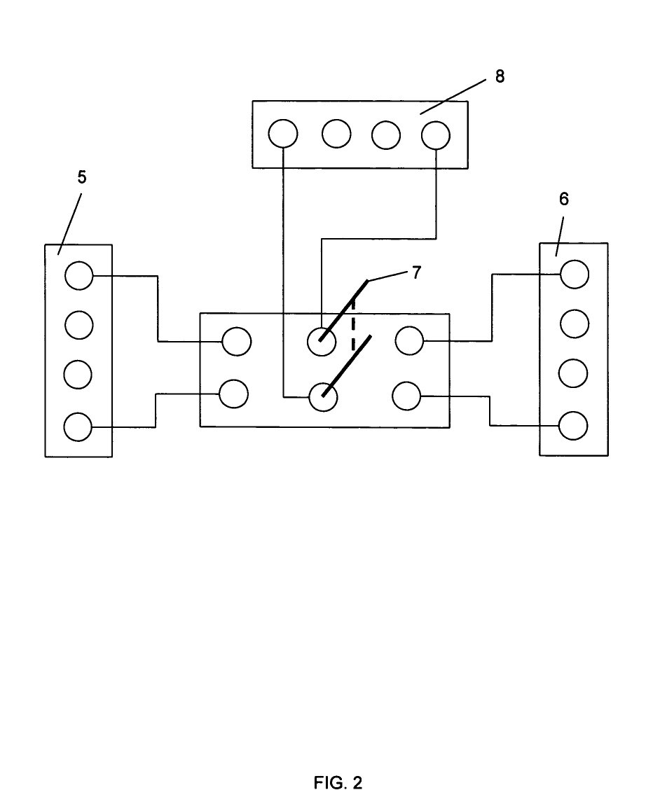

### DETAILED DESCRIPTION OF THE PREFERRED EMBODIMENT(S)

In accordance with the foregoing summary of the invention, the following presents a detailed description of the preferred embodiment of the invention which is presently considered to be its best mode.

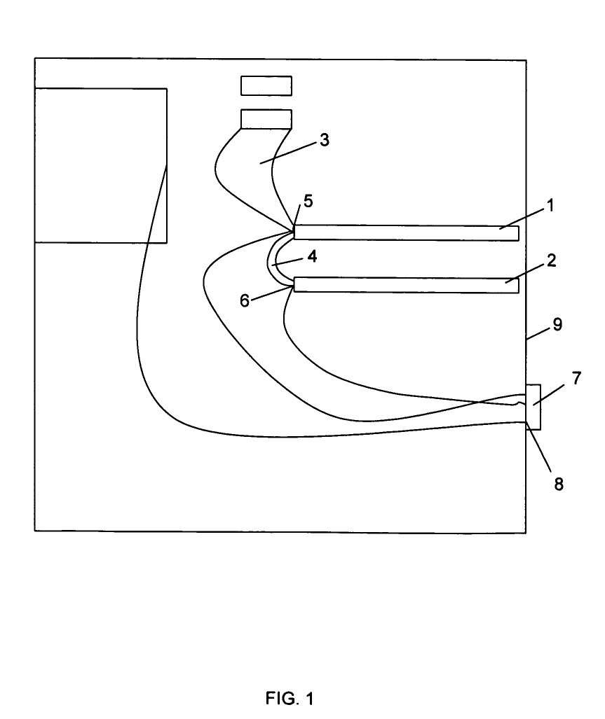

Please refer to FIGS. 1 & 2, which are the structural representation of the present invention. As is shown in figures, it consists of power supply, hard disks 1 & 2, data lines 3 & 4, HD power interfaces 5 & 6, power switch 7, HD power input interface 8 and mainframe panel 9.

Hard disks 1 & 2 used here are: IBM 30G, 80 conductor cable, 7200 rpm; IBM 40G, 80 conductor cable, 7200 rpm. Power switch used here is a 2×2 (220V, 3A) one.

Two identical four-pin outlets for HD1 and HD2 are deployed at the power supply part, with four wires in three different colors. Two black wires in the middle are ground wires, which are grounded together with the case, the back plane grounding and the power interface to provide protection. These ground wires should not be cut off. They are power lines for the hard disks. Cut off the red and the yellow wire, and connect them to different joints of the power switch.

HD data lines 3 & 4 must not be changed (i.e. switched), for line 1 and line 2 will be of no use if there is no power supply for hard disks. They function properly only when the HD1 and HD2 are power-on.

All IDE options should be set to AUTO to prevent BIOS from checking hard disk parameters so as to save the trouble of manual configuration.

For more convenient application, the above-mentioned switch 7 may be directly deployed on the mainframe panel 9.

Above mainframe has not experienced any failure in HD-switching in one year's use.

Moreover, the present invention may also be applied to mainframes with three or more hard disks, and the power switch can be 2×3 (220V, 3A), 2×4 (220V, 3A), or 2×N (220V, 3A). HD interfaces may be SCSI and SATA as well as IDE.

In view of the present disclosure or through practice of the present invention, it will be within the ability of one of ordinary skill to make modifications to the present invention, such as through the use of equivalent arrangements and compositions, in order to practice the invention without departing from the spirit of the invention as reflected in the appended claims.

1. A mainframe computer with multiple switchable disks, said mainframe comprising:
a power supply;
at least two hard disks connected by data lines; and
a 2×N switch (N≧2) deployed between the output interfaces of power supply and input interfaces of hard disks; wherein two four-pin outlets for the hard disks are deployed in the power supply, whose two black wires in the middle are grounded together with the case, the back plane grounding and the power interface and whose red wire and yellow wire are connected to different joints of the 2×N switch.

2. The mainframe computer according to claim 1 wherein said 2×N switch (N≧2) is deployed on a mainframe panel.

3. The mainframe computer according to claim 1 wherein said 2×N switch (N≧2) is compatible with 220V, 3A electricity.

4. A mainframe computer with multiple switchable hard disks, said mainframe computer comprising:
a power supply, said power supply comprising an output interface;
at least two hard disks, each said hard disk comprising an input interface;
a 2×N switch (N≧2) disposed between said output interface and each said input interface of each respective hard disk so as to create a switchable electrical connection between each said hard disk and said power supply, wherein each said hard disk is grounded with the power supply.

5. The mainframe computer according to claim 4 additionally comprising a case.

6. The mainframe computer according to claim 5 wherein each said hard disk is additionally grounded to said case.

7. The mainframe computer according to claim 4 wherein each said hard disk is connected by data lines.

8. The mainframe computer according to claim 4 wherein said power supply has disposed thereon at least two four-pin outlets.
